(19) United States
(12) Patent Application Publication
(10) Pub. No.: US 2026/0316064 A1
(43) Pub. Date: Oct. 15, 2026

(54) CATALYST COMPOSITIONS THAT INCLUDE ZEOLITE WITH REDUCED AVERAGE CRYSTALLINITY

(71) Applicant: Saudi Arabian Oil Company, Dhahran (SA)

(72) Inventors: Isidoro Morales Osorio, Thuwal (SA); Khalid A. Almajnouni, Jeddah (SA); Lujain R. Alfilfil, Thuwal (SA); Mohammed Abdulrahman Hakami, Jeddah (SA)

(73) Assignee: Saudi Arabian Oil Company, Dhahran (SA)

(21) Appl. No.: 19/174,337

(22) Filed: Apr. 9, 2025

(51) Int. Cl. B01J 29/80; B01J 27/224; B01J 29/08; B01J 29/40; C01B 39/02; C01B 39/38; C10G 11/05

(52) U.S. Cl. CPC B01J 29/80; B01J 27/224; B01J 29/084; B01J 29/40; C01B 39/026; C01B 39/38; C10G 11/05; B01J 2229/20; C01P 2002/72

(57) ABSTRACT

According to embodiments, a catalyst composition may comprise from 10 wt. % to 75 wt. % of binder; and from 5 wt. % to 70 wt. % of zeolite, wherein the zeolite comprises a first portion of zeolite having a 10-membered ring pore structure, wherein the first portion of zeolite has an average crystallinity of greater than or equal to 30% and less than or equal to 90%.

### FIELD

The embodiments described herein generally relate to chemical processing and, more particularly, to catalysts.

### BACKGROUND

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as ZSM-5 or Y.

Zeolite containing catalysts and adsorbents have widespread uses in many diverse industries. Exemplary industries include the petrochemical industry in refinery, gas separation, and carbon dioxide separation and capture processes. In the petroleum industry, for example, zeolite containing catalysts may be included in processes such as fluid catalytic cracking (FCC) and hydrocracking to catalyze reactions such as hydrogenation, dehydrogenation, isomerization, alkylation, and cracking. Zeolite containing adsorbents may be utilized in the separation of paraffins or aromatic isomers, and in drying processes to remove water and other impurities from hydrocarbon streams.

### SUMMARY

Embodiments of the present disclosure are directed to catalyst compositions comprising zeolite that is not fully crystalline. It has been discovered that the average crystallinity of a zeolite comprising a 10-membered ring pore structure may affect the catalytic selectivity of the zeolite. For example, a composition comprising a first portion of zeolite having a 10-membered pore ring structure, wherein the first portion of zeolite has a reduced average crystallinity (e.g., greater than or equal to 30% and less than or equal to 90%) may improve the selectivity of the catalyst composition towards light olefins when the catalyst composition is used to process a hydrocarbon feedstock. Further, a composition comprising a first portion of zeolite having a 10-membered pore ring structure, wherein the first portion of zeolite has a reduced average crystallinity may have a higher overall selectivity toward light olefins of the hydrocarbon feedstock when compared to a catalyst composition with a first portion of zeolite having a relatively higher average crystallinity (e.g. greater than 90%), or much lower average crystallinity (e.g. less than 30%). The embodiments described herein incorporate at least one zeolite portion having relatively low average crystallinity. In some embodiments, the catalyst compositions can have improved selectivity while still having sufficient overall conversion. In some additional embodiments, the catalyst compositions may include a mixture of high crystallinity zeolite and relatively low crystallinity zeolite of different types.

According to one or more embodiments disclosed herein a catalyst composition may comprise from 10 wt. % to 75 wt. % of binder; and from 5 wt. % to 70 wt. % of zeolite, wherein the zeolite comprises a first portion of zeolite having a 10-membered ring pore structure, wherein the first portion of zeolite has an average crystallinity of greater than or equal to 30% and less than or equal to 90%.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a reactor system according to one or more embodiments of the present disclosure;

FIG. 2 graphically depicts powder x-ray diffraction (XRD) plots with relative intensity on the y-axis as a function of 2theta in degrees on the x-axis for zeolites of the catalyst compositions disclosed herein;

FIG. 3 graphically depicts powder x-ray diffraction (XRD) plots with relative intensity on the y-axis as a function of 2theta in degrees on the x-axis for zeolites of the catalyst compositions disclosed herein; and

FIG. 4 graphically depicts ammonia temperature programmed desorption (TPD) plots with thermal conductivity detector (TCD) signal on the y-axis as a function of temperature in degrees Celsius on the x-axis for zeolites of the catalyst compositions disclosed herein.

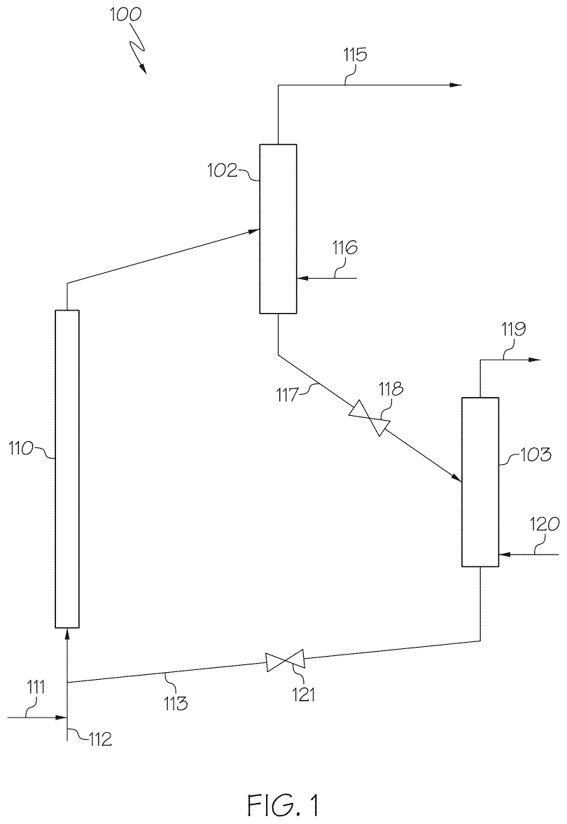

When describing the simplified schematic illustration of FIG. 1, the numerous valves, temperature sensors, electronic controllers, and the like, which may be used and are well known to a person of ordinary skill in the art, are not included. Further, accompanying components that are often included in such reactor systems, such as air supplies, heat exchangers, surge tanks, and the like are also not included. However, it should be understood that these components are within the scope of the present disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. Accompanying components that are in hydrocracking units, such as bleed streams, spent catalyst discharge subsystems, and catalyst replacement sub-systems are also not shown. It should be understood that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some of which are illustrated in the accompanying drawing.

### DETAILED DESCRIPTION

One or more embodiments presently described herein are directed to catalyst compositions comprising a zeolite comprising a first portion of zeolite having a 10-membered ring pore structure, wherein the first portion of zeolite has an average crystallinity of greater than or equal to 30% and less than or equal to 90%. As described herein, and particularly with respect to the Examples that follow, the catalysts described herein may have improved selectivity while still having sufficient overall conversion.

As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure, as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

According to one or more embodiments, the zeolites may be aluminosilicates, meaning that they have a crystalline structure that include silica and alumina. The average crystallinity of the zeolite can affect the properties of the zeolite when the zeolite is used in a chemical reaction. As demonstrated herein, for example, a zeolite having a 10-membered ring pore structure and a relatively low average crystallinity may surprisingly be more selective towards the production of light olefins when used as a catalyst to process a hydrocarbon feedstock and/or have a higher overall hydrocarbon conversion than a zeolite with a relatively higher average crystallinity.

In one or more embodiments, the catalyst composition may comprise, consist essentially of, or consist of from 10 wt. % to 75 wt. % of binder, and from 5 wt. % to 70 wt. % of zeolite. In one or more embodiments, the catalyst composition may comprise, consist essentially of, or consist of from 0 wt. % to 50 wt. % of matrix material, from 10 wt. % to 75 wt. % of binder, and from 5 wt. % to 70 wt. % of zeolite.

In embodiments, the first portion of zeolite having a 10-membered ring pore structure may have an average crystallinity of less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, greater than or equal to 30%, greater than or equal to 35%, greater than or equal to 40%, or from any combination of one or more of these ranges. For example, in embodiments, the first portion of zeolite having a 10-membered ring pore structure may have an average crystallinity of greater than or equal to 30% and less than or equal to 60%. It should be understood that catalyst compositions that include zeolite comprising a first portion of zeolite need not comprise additional portions of zeolite in all embodiments. That is, in some embodiments, the zeolite may consist of the first portion of zeolite.

As described herein, zeolites may be characterized by “average crystallinity.” In general, the average crystallinity is a percentage value that is relative to a fully crystalline zeolite of the same type. For example, a zeolite with an average crystallinity of 75% has 75% of the crystallinity of that same zeolite in fully crystalline form. The average crystallinity of the first or second portions of zeolite may be determined using powder x-ray diffraction to measure a peak height or area, or full width at half maximum of the first or second portions of zeolite relative to a fully crystalline control of a parent zeolite present in the first or second portions of zeolite. The peak heights or areas, or full widths at half maximum may be compared between the fully crystalline sample and the tested sample zeolite to attain the average crystallinity. In embodiments, the average crystallinity of the first or second portions of zeolite are determined using powder x-ray diffraction to measure the area under a characteristic peak of zeolite material and normalized to an area under a characteristic peak of a fully crystalline reference zeolite material. The methods used to determine average crystallinity are further detailed in “Influence of aluminum content, crystallinity and crystallite size of zeolite Pd/H-ZSM-5 on the catalytic performance in the dehydroalkylation of toluene with ethane” Microporous and Mesoporous Materials 109 (2008) 278-286, and “On the Synthesis of ZSM-5 Directly from Kaolin Bangka with Aging Time” Materials Science and Engineering 588 (2019), 012039, both of which are incorporated by reference in their entireties. As described in “Influence of aluminum content, crystallinity and crystallite size of zeolite Pd/H-ZSM-5 on the catalytic performance in the dehydroalkylation of toluene with ethane” Microporous and Mesoporous Materials 109 (2008) 278-286, and “On the Synthesis of ZSM-5 Directly from Kaolin Bangka with Aging Time” Materials Science and Engineering 588 (2019), 012039, the characteristic peaks of the zeolite (e.g. ZSM-5) are identified in an XRD diffractogram. The area under the characteristic peak of the zeolite is calculated and normalized to the integrated area of the fully crystalline reference sample to determine the average crystallinity of each portion of the zeolite in the catalyst composition described herein. In embodiments, the average crystallinity of the first or second portions of zeolite are determined using powder x-ray diffraction to measure the area under a characteristic peak of zeolite material and normalized to an area under a characteristic peak of a fully crystalline reference zeolite material.

Without intending to be bound by any particular theory, it is believed that by utilizing a catalyst composition comprising a first portion of zeolite having a 10-membered ring pore structure, wherein the first portion of zeolite has a reduced average crystallinity, the partially crystalline material may have a modified acidity strength and/or acidity density, which may enhance the conversion of a hydrocarbon feedstock and/or selectivity for producing olefins. Further, it is believed that first portion of zeolite having a reduced average crystallinity may include a combination both crystalline and amorphous structures, which may exhibit a combination of their properties. In the crystalline structures, acidic sites may be stronger as they may be associated with tetrahedral framework of a negatively charged [AlO₄]⁻ unit that is counterbalanced by H⁺ cations, which may result in the crystalline structures being useful for the selective cracking of smaller molecules. In contrast, amorphous structures have a disordered distribution, which may lead to a broader range of acidity, a greater proportion of weaker acidic sites, or both, each of which may provide flexibility in terms of adsorption and diffusion for more effective cracking of larger and more complex molecules. Therefore, it is believed that a synergy between the two phases (crystalline and amorphous) can be used to tune the overall catalytic activity and improve conversion rate and product distribution. Further it is believed that by utilizing the first portion of zeolite, as described herein, a hydrogen transfer reaction may be reduced, which leads to an increase in the light olefins yield.

In embodiments, the zeolite may comprise from 10 wt. % to 60 wt. % of the first portion of zeolite having a 10-membered ring pore structure, based on a total weight of the zeolite. In one or more embodiments, the zeolite may comprise the first portion of zeolite in an amount from 10 wt. % to 15 wt. %, from 15 wt. % to 20 wt. %, from 20 wt. % to 25 wt. %, from 25 wt. % to 30 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. %, from 75 wt. % to 80 wt. %, from 80 wt. % to 85 wt. %, from 85 wt. % to 90 wt. %, from 90 wt. % to 95 wt. %, from 95 wt. % to 100 wt. %, or from any combination of one or more of these ranges.

In embodiments, the zeolite may further comprise a second portion of zeolite having a 12-membered ring pore structure. In embodiments, the second portion of zeolite having a 12-membered ring pore structure may have an average crystallinity of greater than or equal to 80%, greater than or equal to 90%, greater than or equal to 95%, or greater than or equal to 99%.

In embodiments, the zeolite may comprise from 0 wt. % to 90 wt. % of the second portion of zeolite having a 12-membered ring pore structure, based on a total weight of the zeolite. In one or more embodiments, the zeolite may comprise the second portion of zeolite in an amount from 10 wt. % to 15 wt. %, from 15 wt. % to 20 wt. %, from 20 wt. % to 25 wt. %, from 25 wt. % to 30 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, from 60 wt. % to 65 wt. %, from 65 wt. % to 70 wt. %, from 70 wt. % to 75 wt. %, from 75 wt. % to 80 wt. %, from 80 wt. % to 85 wt. %, from 85 wt. % to 90 wt. %, or from any combination of one or more of these ranges.

Without intending to be bound by any particular theory, it is believed that by utilizing a catalyst composition comprising a second portion of zeolite having a 12-membered ring pore structure, the second portion of zeolite may preferentially crack bulkier molecules present in the feedstock.

The zeolite may comprise 99 wt. % or more of the combination of the first portion of zeolite and the second portion of the zeolite.

In embodiments, a ratio of the first portion of zeolite to the second portion of zeolite may be from 1:10 to 10:1. For example, in embodiments, a ratio of the first portion of zeolite to the second portion of zeolite may be from 1:10 to 1:9, from 1:9 to 1:8, from 1:8 to 1:7, from 1:7 to 1:6, from 1:6 to 1:5, from 1:5 to 1:4, from 1:4 to 1:3, from 1:3 to 1:2, from 1:2 to 1:1, from 1:1 to 2:1, from 2:1 to 3:1, from 3:1 to 4:1, from 4:1 to 5:1, from 5:1 to 6:1, from 6:1 to 7:1, from 7:1 to 8:1, from 8:1 to 9:1, from 9:1 to 10:1, or from any combination of one or more of these ranges.

The first portion of zeolite may comprise any framework type of zeolite that has a 10-membered ring pore structure and an appropriate relative crystallinity, as described hereinabove. In one or more embodiments, the first portion of zeolite may comprise a ZSM-5 zeolite. As used throughout this disclosure, “ZSM-5” generally refers to zeolites having an MFI framework type according to the IZA zeolite nomenclature and consisting majorly of silica and alumina, as is understood by those skilled in the art. ZSM-5 refers to “Zeolite Socony Mobil-5” and is a pentasil family zeolite that can be represented by the chemical formula NaₙAlₙSi₉₆-nO₁₉₂·16H₂O, where 0<n<27.

The second portion of zeolite may comprise any framework type of zeolite that has a 12-membered ring pore structure and an appropriate relative crystallinity, as described hereinabove. In one or more embodiments, the second portion of zeolite may comprise a zeolite Y. As used throughout this disclosure, “zeolite Y” and “USY” refer to a zeolite having a FAU framework type according to the IZA zeolite nomenclature and consisting majorly of silica and alumina, as would be understood by one skilled in the art.

As described hereinabove, in one or more embodiments the catalyst composition may comprise from 5 wt. % to 70 wt. % of zeolite, based on a total weight of the catalyst composition. For example, the catalyst composition may include from 5 wt. % to 10 wt. % of zeolite, from 10 wt. % to 15 wt. % of zeolite, from 15 wt. % to 20 wt. % of zeolite, from 20 wt. % to 25 wt. % of zeolite, from 25 wt. % to 30 wt. % of zeolite, from 30 wt. % to 35 wt. % of zeolite, from 35 wt. % to 40 wt. % of zeolite, from 40 wt. % to 45 wt. % of zeolite, from 45 wt. % to 50 wt. % of zeolite, from 50 wt. % to 55 wt. % of zeolite, from 55 wt. % to 60 wt. % of zeolite, from 60 wt. % to 65 wt. % of zeolite, from 65 wt. % to 70 wt. % of the zeolite, or from any combination of one or more of these ranges.

In one or more embodiments, the catalyst composition may comprise one or more binder materials, such as alumina-containing compounds or silica-containing compounds (including compounds containing alumina and silica). As used throughout this disclosure, “binder materials” refer to materials that may serve to “glue” or otherwise hold components of the catalyst composition together in the microsphere. It may improve the attrition resistance of the catalyst particle. For example, the binder material may comprise alumina (such as amorphous alumina), silica-alumina (such as amorphous silica-alumina), or silica (such as amorphous silica). According to one or more embodiments, the binder material may comprise pseudoboehmite. As used in this disclosure, “pseudoboehmite” refers to an aluminum-containing compound with the chemical composition AIO (OH) consisting of crystalline boehmite. Suitable pseudoboehmite includes CATAPAL® aluminas, commercially available from Sasol Limited of Johannesburg, South Africa. Boehmite refers to aluminum oxide hydroxide as well, but pseudoboehmite generally has a greater amount of water than boehmite. The binder material, such as pseudoboehmite, may be peptized with an acid, such as a mono-protic acid, such as nitric acid (“HNO₃”) or hydrochloric acid (“HCl”).

According to one or more embodiments, the catalyst composition may comprise from 10 wt. % to 75 wt. % of binder. For example, the catalyst composition may comprise from 10 wt. % to 15 wt. % of binder, from 15 wt. % to 20 wt. % of binder, from 20 wt. % to 25 wt. % of binder, from 25 wt. % to 30 wt. % of binder, from 30 wt. % to 35 wt. % of binder, from 35 wt. % to 40 wt. % of binder, from 40 wt. % to 45 wt. % of binder, from 45 wt. % to 50 wt. % of binder, from 50 wt. % to 55 wt. % of binder, from 55 wt. % to 60 wt. % of binder, from 60 wt. % to 65 wt. % of binder, from 65 wt. % to 70 wt. % of binder, from 70 wt. % to 75 wt. % of binder, or from any combination of one or more of these ranges. It should be understood that, in one or more embodiments, the catalyst composition may include any single disclosed binder material in an amount of the discloses wt. % ranges. In additional embodiments, the catalyst composition may include any two or more binder materials in combination in any amount of the disclosed wt. % ranges.

In one or more embodiments, the binder may comprise a clay material such as kaolin. Without being bound by theory, it is believed that the binder materials of the catalyst composition may serve both physical and catalytic functions. Physical functions include providing particle density, acting as a heat transfer medium

In one or more embodiments, the binder material comprises kaolin. As used in this disclosure, “kaolin” refers to a clay material that has a relatively large amount (such as at least about 50 wt. %, at least 60 wt. %, at least 70 wt. %, at least 80 wt. %, at least 90 wt. %, or even at least 95 wt. %) of kaolinite, which can be represented by the chemical formula Al₂Si₂O₅(OH)₄. Kaolin is sometimes referred to as “china clay.” In additional embodiments, the matrix material may comprise other clay materials.

Additives, such as matrix materials may be added to the catalyst composition to achieve specific properties. Without being bound by theory, it is believed that the matrix materials of the catalyst composition may serve both physical and catalytic functions. The matrix can also affect catalyst selectivity, product quality and resistance to poisons. The matrix materials may tend to exert its strongest influence on overall catalytic properties for those reactions, which directly involve relatively large molecules. Matrix materials can be amorphous alumina-silicate or any metals trap components that are known in the open literatures. In one or more embodiments, the catalyst composition may further comprise matrix materials. In one or more embodiments, the catalyst composition may comprise from 0 wt. % to 40 wt % matrix materials. For example, the catalyst composition may comprise from 0 wt. % to 5 wt. % of matrix materials, 5 wt. % to 10 wt. % of matrix materials, 10 wt. % to 15 wt. % of matrix materials, 15 wt. % to 20 wt. % of matrix materials, 20 wt. % to 25 wt. % of matrix materials, 25 wt. % to 30 wt. % of matrix materials, 30 wt. % to 35 wt. % of matrix materials, 35 wt. % to 40 wt. % of matrix materials, or from any combination of one or more of these ranges. It should be understood that, in one or more embodiments, the catalyst composition may include any single disclosed matrix material in an amount of the discloses wt. % ranges.

Metal carbides (MC) in the formulation may act as diluents that increase the density of the catalyst particle and improve its thermal conductivity. Better thermal conductivities aid in stabilizing the temperature profile of the catalyst bed and reduce cold/hot spots. In one or more embodiments, the catalyst composition may further comprise silicon carbide particles. In one or more embodiments, the catalyst composition may further comprise from 1 wt. % to 40 wt. % of silicon carbide particles. For example, the catalyst composition may comprise from 1 wt. % to 5 wt. %, from 5 wt. % to 10 wt. % of silicon carbide particles, from 10 wt. % to 15 wt. % of silicon carbide particles, from 15 wt. % to 20 wt. % of silicon carbide particles, from 20 wt. % to 25 wt. % of silicon carbide particles, from 25 wt. % to 30 wt. % of silicon carbide particles, from 30 wt. % to 35 wt. % of silicon carbide particles, from 35 wt. % to 40 wt. % of silicon carbide particles, or from any combination of one or more of these ranges. In one or more embodiments, the silicon carbide particles may have an average particle size of from 50 nm to 900 nm. For example the silicon carbide particles may have an average particle size of from 50 nm to 100 nm, from 100 nm to 150 nm, from 150 nm to 200 nm, from 200 nm to 250 nm, from 250 nm to 300 nm, from 300 nm to 350 nm, from 350 nm to 400 nm, from 400 nm to 450 nm, from 450 nm to 500 nm, from 500 nm to 550 nm, from 550 nm to 600 nm, from 600 nm to 650 nm, from 650 nm to 700 nm, from 700 nm to 750 nm, from 750 nm to 800 nm, from 800 nm to 850 nm, from 850 nm to 900 nm, or from any combination of one or more of these ranges.

In one or more embodiments, the catalyst composition may be formed as particles. The particles may be shaped particles, such as spheres, or may be inconsistent in shape or otherwise globular in shape. The size of a particle refers to the maximum length of a particle from one side to another, measured along the longest distance of the particle. For example, a spherically shaped particle has a size equal to its diameter, or a rectangular prism shaped particle has a maximum length equal to the hypotenuse stretching from opposite corners. The particles of the catalyst composition may have an average diameter ranging from 20 microns to 200 microns, such as from 20 microns to 30 microns, from 30 microns to 40 microns, from 40 microns to 50 microns, from 50 microns to 60 microns, from 60 microns to 70 microns, from 70 microns to 80 microns, from 80 microns to 90 microns, from 90 microns to 100 microns, or from any combination of one or more of these ranges. Average particle size can be measured using laser diffraction analysis.

In one or more embodiments, the first and second portions of zeolite may be present on the same particle. In other embodiments, the first and second portions of zeolite may each be present on different particles.

In one or more embodiments, the catalyst composition of the present disclosure may be used to process hydrocarbons. In one or more embodiments, a method for processing hydrocarbons may comprise passing a hydrocarbon feedstock to a reactor, contacting the hydrocarbon feedstock with the catalyst compositions of the present disclosure to produce a product stream, and passing the product stream out of the reactor. Now turning to FIG. 1, an example fluid catalytic cracking (FCC) system that may be utilized with the catalyst compositions and methods of the present disclosure is shown. In FIG. 1 the FCC system 100 includes a line 111 through which a hydrocarbon feedstock is supplied. The hydrocarbon feedstock may generally comprise a hydrocarbon material. In embodiments, the hydrocarbon material of the hydrocarbon feed stream may be crude oil. As used in this disclosure, the term “crude oil” is to be understood to mean a mixture of petroleum liquids, gases, or combinations of liquids and gases, including some embodiments impurities such as sulfur-containing compounds, nitrogen-containing compounds and metal compounds that has not undergone significant separation or reaction processes. Crude oils are distinguished from fractions of crude oil. In certain embodiments, the crude oil feedstock may be a minimally treated light crude oil to provide a crude oil feedstock having total metals (Ni+V) content of less than 30 parts per million by weight (ppmw) and Conradson carbon residue of less than 10 wt %. Such minimally treated materials may be considered crude oils as described herein.

While the present description and examples may specify crude oil as the hydrocarbon material of the hydrocarbon feedstock, it should be understood that FCC system 100 described with respect to the embodiments of FIG. 1, or any fluidized bed regime known in the field may be applicable for the conversion of a wide variety of hydrocarbon materials, which may be present in the hydrocarbon feedstock, including, but not limited to, crude oil, vacuum residue, tar sands, bitumen, atmospheric residue, vacuum gas oils, demetallized oils, naphtha streams, other hydrocarbon streams, or combinations of these materials. The hydrocarbon feedstock may include one or more non-hydrocarbon constituents, such as one or more heavy metals, sulphur compounds, nitrogen compounds, inorganic components, or other non-hydrocarbon compounds. If the hydrocarbon feedstock is crude oil, it may have an American Petroleum Institute (API) gravity of from 22 degrees to 40 degrees. For example, the hydrocarbon feedstock utilized may be an Arab heavy crude oil. (API gravity of approximately) 28°, Arab medium (API gravity of approximately) 30°, Arab light (API gravity of approximately 33°), or Arab extra light (API gravity of approximately 39°). It should be understood that, as used in this disclosure, a “hydrocarbon feedstock” may refer to a raw hydrocarbon material which has not been previously treated, separated, or otherwise refined (such as crude oil) or may refer to a hydrocarbon material which has undergone some degree of processing, such as treatment, separation, reaction, purifying, or other operation, prior to being introduced to the FCC system 100 from line 111.

In general, the contents of the hydrocarbon feedstock may include a relatively wide variety of chemical species based on boiling point. For example, the hydrocarbon feed stream 102 may have composition such that the difference between the 5 wt. % boiling point and the 95 wt. % boiling point of the hydrocarbon feed stream 102 is at least 100° C., at least 200° C., at least 300° C., at least 400° C., at least 500° C., or even at least 600° C.

Referring back to FIG. 1, the feedstock enters into a line 112, which carries steam or gas, for dilution. The mixture enters then a riser 110, which is a reaction zone. A regenerated catalyst, which may be the catalyst composition of the present disclosure, is also supplied to the riser 110 through a line 113. The steam or gas, when mixed with the feedstock, increases the selectivity of the light olefin hydrocarbons while making the flow of the regenerated catalyst efficient. The regenerated catalyst is supplied along line 113 from a regenerator 103, which is a separate entity from the riser 110. The temperature inside the regenerator 103 needs to be high to achieve the gasification of the feedstock.

The steam supplied by line 112 fluidizes the feedstock and catalyst, which are mixed at the bottom of the riser 110, and moves this mixture to the top of the riser while the mixture is subject to the cracking process. Because the cracking process is an endothermic process, the temperature of the mixture decreases, and thus, the temperature of the upper portion of the riser 110 is lowered. The products reaching the top of the riser 110 are then entering a stripper 102 that separates the gas products from the solid products. To increase the efficiency of the separation process, a cyclone may be used. The separated gas is removed along a line 115 and the separated catalyst is moved to the bottom of the stripper 102. Stripping steam is supplied along line 116 to the bottom portion of the stripper to remove the non-separated hydrocarbon reaction products. The catalyst is transferred along a line 117, under control of a valve 118, to the regenerator 103. In the regenerator, coke attached to the catalyst interacts with an oxidant supplied along line 120 so that the coke transforms into carbon monoxide or carbon dioxide, which is removed along line 119. The regenerated catalyst is supplied back to the riser 110 along line 113. Valve 121 controls the amount of regenerated catalyst that flows along the line 113.

During the FCC process described above, the cracking reaction is achieved in a riser or downer, where the catalyst and feedstock flow together in an entrained flow and are separated by using cyclones and strippers. The coked catalyst is regenerated in a separate vessel, which is operated at a higher temperature and residence time. Other suitable systems that may utilize the catalyst compositions of the present disclosure include those described in U.S. Pat. No. 11,446,625, U.S. Patent Publication No. 2022/0033714, and U.S. Pat. No. 11,965,133, the entireties of each which are incorporated by reference herein.

### EXAMPLES

The various embodiments of the catalyst compositions described will be further clarified by the following examples. The examples are illustrative in nature, and should not be to limit the subject matter of the present disclosure.

### Example 1—Catalyst Composition Preparation

A number of catalyst compositions were prepared with ZSM-5 zeolites having a different average crystallinity. The ZSM-5 zeolites were prepared as follows. A silica source gel (gel 1) was prepared by mixing sodium hydroxide (NaOH) pellets with deionized water in a sealed polypropylene container. The mixture was then stirred continuously until the NaOH pellets were completely dissolved. Colloidal silica (40 wt. % SiO₂ in H₂O, commercially available as LUDOX® AS-40 from Sigma Aldrich) was added to the solution and kept under stirring for at least 5 hours to form gel 1. An aluminum source gel (Gel 2) was prepared by mixing NaOH pellets and deionized water in a separate polypropylene container and stirred until fully dissolved. NaAlO₂ was added to the solution and stirred constantly for at least 5 hours to form Gel 2. Gel 1 and Gel 2 were combined in a sealed polypropylene container and vigorously stirred for 5 hours. The mixture was then transferred to a 125 mL Teflon-lined Parr Stainless Steel Autoclave and securely sealed. The mixture was then placed in a preheated rotation oven at 160° C. for a duration of either 20, 25, 27, 30, or 39 hours to crystallize the material. After the set crystallization time, the autoclave was removed from the oven and cooled rapidly under a stream of cold tap water. The solid product was collected by centrifugation and decantation and washed thoroughly with deionized water during the decantation steps. Drying and weighing of the ZSM-5 product was then carried out. The product was ion-exchanged in a solution of 1 M NH₄NO₃ for 3 hours and repeated for 3 times to produce NH₄-ZSM-5. The H-form of the zeolite (H-ZSM-5) was obtained by calcining the NH₄-ZSM-5 at 550° C. for 5 hours.

The ZSM-5 produced with varying crystallization time (20, 25, 27, 30, or 39 hours) was further characterized. Powder X-ray diffraction (XRD) and temperature-programmed desorption of NH₃ (NH₃-TPD) were used to investigate how crystallization time affected the structure of the ZSM-5 zeolite. XRD was performed after hydrothermal treatment and sample recovery including washing and drying and before ion exchange. The NH₃-TPD data was obtained after ion exchange and further calcination to obtain the active H-form of the zeolite.

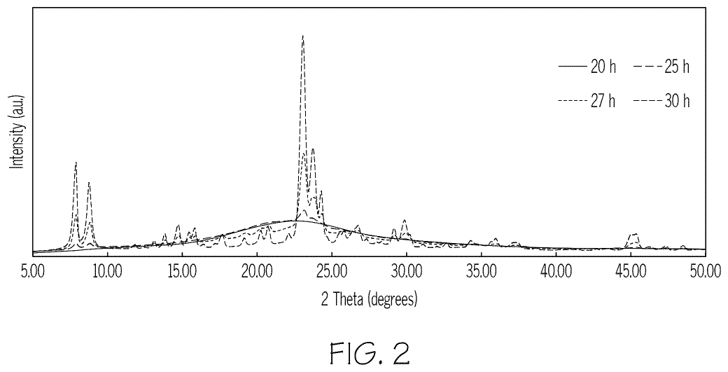

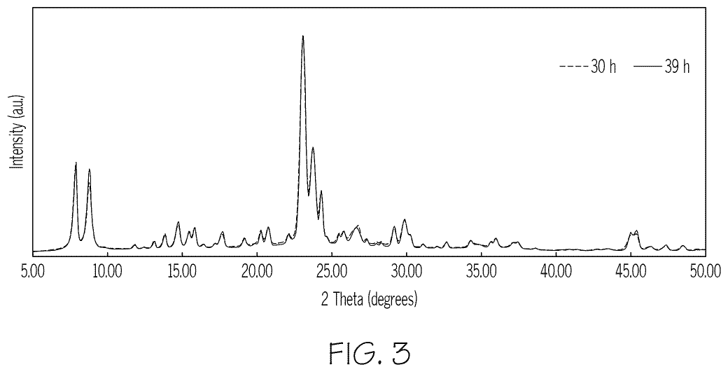

The powder XRD data are shown in FIG. 2 with relative intensity on the y-axis as a function of 2theta in degrees on the x-axis for the ZSM-5 zeolites formed using a crystallization time of 20, 25, 27, or 30 hours corresponding to zeolite A, B, C, and D, respectively. FIG. 2 shows that at 20 hours (A), a completely amorphous structure is observed with a single broad peak in the XRD pattern. As the crystallization time increases, characteristic peaks of the MFI structure observed and completed at 30 hours (D). FIG. 3 depicts the XRD data for the ZSM-5 zeolites formed using a crystallization time of 30 hours or 39 hours corresponding to zeolite D and E, respectively. As shown in FIG. 3, further increasing the crystallization time from 30 hours to 39 hours did not result in any further change in the XRD plot, suggesting that crystallization is completed after 30 hours. The average crystallinity of zeolites A, B, and C, were calculated by comparing the relative peak height normalized to the peak of zeolite D using the methods described herein and are reported in Table 1.

TABLE 1

| | Crystallization | Average |
|---|---|---|
| Zeolite | Time (hr) | Crystallinity (%) |
| A | 20 | 0 |
| B | 25 | 9.1 |
| C | 27 | 42.6 |
| D | 30 | 100 |

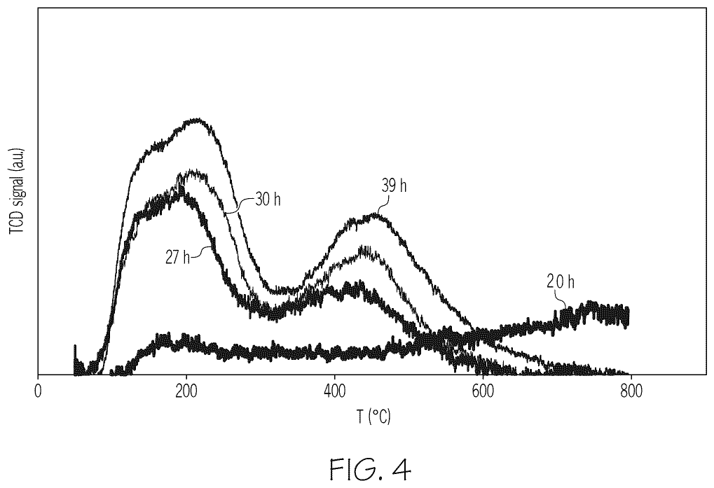

FIG. 4 depicts the NH₃-TPD spectra of zeolites A, B, C, and D. As shown in FIG. 4, increased crystallization time resulted in more well-defined crystals leading to higher proportion of strong acid sites while shorter crystallization time created defects in the zeolite framework.

Catalyst compositions comprising the H-ZSM-5 (A, B, C, or D) were prepared, corresponding to Catalyst Compositions 1, 2, 3, and 4, respectively. In particular, Pural SB grade alumina was mixed with distilled water to form an alumina binder slurry. Kaolin clay was added to the alumina binder slurry and stirred for 5 minutes, followed by the addition of the H-ZSM-5 and stirring, followed by the addition of colloidal silica (40 wt. % SiO₂ in H₂O, commercially available as LUDOX® AS-40 from Sigma Aldrich) and stirring. The mixture was stirred for 25 minutes at room temperature and was then heated to approximately 50° C.-60° C. for 2-3 hours until a solid cake formed. The material was dried overnight at a temperature of 80° C. to 100° C. After drying, the material was calcined according to the following program: increase the temperature from room temperature to 125° C. at a rate of 3° C. per minute, hold the temperature at 125° C. for 30 minutes, increase the temperature from 125° C. to 250° C. at a rate of 4° C. per minute, hold the temperature at 250° C. for 60 minutes, increase the temperature from 250° C. to 550° C. at a rate of 2° C. per minute, and hold the temperature at 550° C. for 90 minutes. After calcination, the catalyst was sieved and the fraction between 50-100 microns was collected for further testing. The compositions of the catalyst compositions were recorded in Table 2.

TABLE 2

| | | | | | Binder, wt. % | | |
|---|---|---|---|---|---|---|---|
| | | | | | | | Kaolin |
| Catalyst | Zeolites wt. % | | | | | Ludox | Clay |
| Composition | A | B | C | D | Al₂Cl(OH)₅ | AS-40 | wt. % |
| 1 | 40 | — | — | — | 15 | 10 | 35 |
| 2 | — | 40 | — | — | 15 | 10 | 35 |
| 3 | — | — | 40 | — | 15 | 10 | 35 |
| 4 | — | — | — | 40 | 15 | 10 | 35 |

### Example 2—Catalytic Testing

Catalytic performance testing of the Catalyst Compositions 1-4 was carried out in a riser simulator reactor, which is a bench-scale internal recycle batch reactor. The feedstock used in the reaction was n-hexane and all experiments were performed at 500° C., a 7.6 catalyst to oil ratio, and 5 seconds contact time. The resulting conversion %, and paraffin/olefin molar ratio using the catalyst compositions are reported in Table 3.

TABLE 3

| Catalyst | ZSM-5 | | Paraffins/Olefins |
|---|---|---|---|
| Composition | crystallinity | Conversion % | (Molar ratio) |
| 1 | 0% | 0.69 | 1.69 |
| 2 | 9.1% | 4.22 | 1.23 |
| 3 | 42.6% | 11.57 | 1.92 |
| 4 | 100% | 7.31 | 2.91 |

As shown in Table 3, the catalyst composition comprising ZSM-5 having an average crystallinity of 42.6% resulted in enhanced conversion of n-hexane to light olefins (Catalyst 3) compared to the catalyst compositions comprising ZSM-5 having no crystallinity (Catalyst 1), complete crystallinity (Catalyst 4), or a further reduced crystallinity of 9.1% (Catalyst 2). Overall, the Examples indicate that by selecting a zeolite comprising a first portion of zeolite having a 10-membered pore ring structure having a reduced average crystallinity (e.g., greater than or equal to 30% and less than or equal to 60%), one can improve overall conversion of the reaction without sacrificing selectivity towards a target product or products.

The present disclosure includes numerous aspects. A first aspect is a composition comprising: f rom 10 wt. % to 75 wt. % of binder; and from 5 wt. % to 70 wt. % of zeolite, wherein the zeolite comprises a first portion of zeolite having a 10-membered ring pore structure, wherein the first portion of zeolite has an average crystallinity of greater than or equal to 30% and less than or equal to 90%.

Another aspect is any previous aspect or combination of previous aspects, wherein the zeolite further comprises from a second portion of zeolite having a 12-membered ring pore structure, wherein the second portion of zeolite has an average crystallinity of greater than or equal to 90%.

Another aspect is any previous aspect or combination of previous aspects, wherein the zeolite comprises from 10 wt. % to 90 wt. % of the first portion of zeolite and from 10 wt. % to 90 wt. % of the second portion of zeolite.

Another aspect is any previous aspect or combination of previous aspects, wherein the zeolite comprises 99 wt. % or more of the combination of the first portion of zeolite and the second portion of zeolite.

Another aspect is any previous aspect or combination of previous aspects, wherein a ratio of the first portion of zeolite to the second portion of zeolite is from 1:5 to 5:1.

Another aspect is any previous aspect or combination of previous aspects, wherein the second portion of zeolite comprises zeolite Y.

Another aspect is any previous aspect or combination of previous aspects, wherein the first portion of zeolite comprises ZSM-5 zeolite.

Another aspect is any previous aspect or combination of previous aspects, wherein the catalyst composition is formed as particles.

Another aspect is any previous aspect or combination of previous aspects, wherein: the zeolite further comprises a second portion of zeolite having a 12-membered ring pore structure, wherein the second portion of zeolite has an average crystallinity of greater than or equal to 90%; and the first and second portions of zeolite are each present on the same particles.

Another aspect is any previous aspect or combination of previous aspects, wherein: the zeolite further comprises a second portion of zeolite having a 12-membered ring pore structure, wherein the second portion of zeolite has an average crystallinity of greater than or equal to 90%; and the first and second portions of zeolite are each present on separate particles.

Another aspect is any previous aspect or combination of previous aspects, wherein the first portion of zeolite has an average crystallinity of greater than or equal to 30% and less than or equal to 60%.

Another aspect is any previous aspect or combination of previous aspects, wherein the binder comprises silica, alumina, kaolin or combinations thereof.

Another aspect is any previous aspect or combination of previous aspects, further comprising from 1 wt. % to 40 wt. % matrix material.

Another aspect is any previous aspect or combination of previous aspects, further comprising from 1 wt. % to 40 wt. % of silicon carbide particles.

Another aspect is any previous aspect or combination of previous aspects, wherein the silicon carbide particles have an average particle size of from 50 nm to 900 nm.

Another aspect is any previous aspect or combination of previous aspects, wherein: the catalyst composition comprises: from 50 wt. % to 70 wt. % of the binder; and from 30 wt. % to 50 wt. % of the zeolite, the first portion of zeolite has an average crystallinity of greater than or equal to 30% and less than or equal to 60%.

Another aspect is any previous aspect or combination of previous aspects, wherein: the catalyst composition comprises: from 50 wt. % to 70 wt. % of the binder; and, from 30 wt. % to 50 wt. % of the zeolite; the first portion of zeolite has an average crystallinity of greater than or equal to 30% and less than or equal to 60%; and the first portion of zeolite comprises ZSM-5 zeolite.

Another aspect is any previous aspect or combination of previous aspects, wherein: the first portion of zeolite comprises ZSM-5 zeolite; the first portion of zeolite has an average crystallinity of greater than or equal to 30% and less than or equal to 60%; the zeolite further comprises a second portion of zeolite having a 12-membered ring pore structure; the second portion of zeolite has an average crystallinity of greater than or equal to 90%; and the second portion of zeolite comprises zeolite Y.

Another aspect is a method for processing hydrocarbons comprising passing a hydrocarbon feedstock to a reactor, contacting the hydrocarbon feedstock with the catalyst composition of any previous aspect or combination of aspects to produce a product stream, and passing the product stream out of the reactor.

Another aspect is any previous aspect or combination of previous aspects, wherein the hydrocarbon feedstock comprises crude oil.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

What is claimed is:

1. A catalyst composition comprising:
from 10 wt. % to 75 wt. % of binder; and
from 5 wt. % to 70 wt. % of zeolite, wherein the zeolite comprises a first portion of zeolite having a 10-membered ring pore structure, wherein the first portion of zeolite has an average crystallinity of greater than or equal to 30% and less than or equal to 90%.

2. The catalyst composition of claim 1, wherein the zeolite further comprises from a second portion of zeolite having a 12-membered ring pore structure, wherein the second portion of zeolite has an average crystallinity of greater than or equal to 90%.

3. The catalyst composition of claim 2, wherein the zeolite comprises from 10 wt. % to 90 wt. % of the first portion of zeolite and from 10 wt. % to 90 wt. % of the second portion of zeolite.

4. The catalyst composition of claim 2, wherein the zeolite comprises 99 wt. % or more of the combination of the first portion of zeolite and the second portion of zeolite.

5. The catalyst composition of claim 2, wherein a ratio of the first portion of zeolite to the second portion of zeolite is from 1:5 to 5:1.

6. The catalyst composition of claim 2, wherein the second portion of zeolite comprises zeolite Y.

7. The catalyst composition of claim 1, wherein the first portion of zeolite comprises ZSM-5 zeolite.

8. The catalyst composition of claim 1, wherein the catalyst composition is formed as particles.

9. The catalyst composition of claim 8, wherein:
the zeolite further comprises a second portion of zeolite having a 12-membered ring pore structure, wherein the second portion of zeolite has an average crystallinity of greater than or equal to 90%; and
the first and second portions of zeolite are each present on the same particles.

10. The catalyst composition of claim 8, wherein:
the zeolite further comprises a second portion of zeolite having a 12-membered ring pore structure, wherein the second portion of zeolite has an average crystallinity of greater than or equal to 90%; and
the first and second portions of zeolite are each present on separate particles.

11. The catalyst composition of claim 1, wherein the first portion of zeolite has an average crystallinity of greater than or equal to 30% and less than or equal to 60%.

12. The catalyst composition of claim 1, wherein the binder comprises silica, alumina, kaolin or combinations thereof.

13. The catalyst composition of claim 1, further comprising from 1 wt. % to 40 wt. % matrix material.

14. The catalyst composition of claim 1, further comprising from 1 wt. % to 40 wt. % of silicon carbide particles.

15. The catalyst composition of claim 14, wherein the silicon carbide particles have an average particle size of from 50 nm to 900 nm.

16. The catalyst composition of claim 1, wherein:
the catalyst composition comprises:
from 50 wt. % to 70 wt. % of the binder; and
from 30 wt. % to 50 wt. % of the zeolite,
the first portion of zeolite has an average crystallinity of greater than or equal to 30% and less than or equal to 60%.

17. The catalyst composition of claim 1, wherein:
the catalyst composition comprises:
from 50 wt. % to 70 wt. % of the binder; and
from 30 wt. % to 50 wt. % of the zeolite;
the first portion of zeolite has an average crystallinity of greater than or equal to 30% and less than or equal to 60%; and
the first portion of zeolite comprises ZSM-5 zeolite.

18. The catalyst composition of claim 1, wherein:
the first portion of zeolite comprises ZSM-5 zeolite;
the first portion of zeolite has an average crystallinity of greater than or equal to 30% and less than or equal to 60%;
the zeolite further comprises a second portion of zeolite having a 12-membered ring pore structure;
the second portion of zeolite has an average crystallinity of greater than or equal to 90%; and
the second portion of zeolite comprises zeolite Y.

19. A method for processing hydrocarbons, the method comprising:
passing a hydrocarbon feedstock to a reactor;
contacting the hydrocarbon feedstock with the catalyst composition of claim 1 to produce a product stream; and
passing the product stream out of the reactor.

20. The method of claim 19, wherein the hydrocarbon feedstock comprises crude oil.
